(19) United States
(12) Patent Application Publication
(10) Pub. No.: US 2022/0146429 A1
(43) Pub. Date: May 12, 2022

(54) SINGLE WAVELENGTH RAMAN ANALYZER

(71) Applicant: Salvo Technologies, Inc., Largo, FL (US)

(72) Inventor: Hugh Garvey, Seminole, FL (US)

(21) Appl. No.: 17/501,039

(22) Filed: Oct. 14, 2021

Related U.S. Application Data
(60) Provisional application No. 63/112,242, filed on Nov. 11, 2020.

(51) Int. Cl. G01N 21/65

(52) U.S. Cl. CPC G01N 21/65; G01N 2201/0636; G01N 2201/06113

(57) ABSTRACT

The device and method of a narrow range or single wavelength Raman analyzer instrument optimized to capture a narrow range, or even single wavenumber, of signal spectrum known to be significant to the substance under analysis is disclosed.

### CROSS-REFERENCE TO RELATED APPLICATION

The present application claims the benefit of previously filed Provisional Patent Application, Ser. No. 63/112,242 filed on Nov. 11, 2020.

### FIELD OF THE INVENTION

The device and method of this disclosure belongs to the field of Raman Scattering spectroscopy. More specifically it is the use of an instrument optimized to capture a narrow range, or even single wavenumber of signal spectrum known to be significant to the substance under analysis.

### BACKGROUND OF THE INVENTION

Raman spectroscopy is a form of vibrational spectroscopy, much like infrared (IR) spectroscopy. However, whereas IR bands arise from a change in the dipole moment of a molecule due to an interaction of light with the molecule, Raman bands arise from a change in the polarizability of the molecule due to the same interaction. This means that these observed bands (corresponding to specific energy transitions) arise from specific molecular vibrations. When the energies of these transitions are plotted as a spectrum, they can be used to identify the molecule as they provide a “molecular fingerprint” of the molecule being observed. Certain vibrations that are allowed in Raman are forbidden in IR, whereas other vibrations may be observed by both techniques, although at significantly different intensities, thus these techniques can be thought of as complementary.

Since the discovery of the Raman effect in 1928 by C. V. Raman and K. S. Krishnan, Raman spectroscopy has become an established, as well as a practical, method of chemical analysis and characterization applicable to many different chemical species.

Conventional Raman Spectroscopy requires expensive instrumentation, which is often difficult to operate, and may require chemical and/or spectroscopic know-how to interpret the results. The simplified optical arrangement of this disclosure, optimized only for a single application can be, inexpensive, simple to operate and the results presented for interpretation by anyone. The method disclosed in this application can use a single detector for a spot analysis, or use an array of detectors or a detector array to cover a wider field of view and thus is a significant improvement over prior art systems and methods.

### BRIEF SUMMARY OF THE INVENTION

The device and method of this disclosure belongs to the field of Raman Scattering spectroscopy. More specifically it is the use of an instrument optimized to capture a narrow range, or even single wavenumber of signal spectrum known to be significant to the substance under analysis. In the disclosed invention the Raman signal from a substance under analysis is collected by a much-simplified optical arrangement which is optimized to capture a narrow range or even a single wavenumber of the signal spectrum known to be significant for the substance under analysis.

### BRIEF DESCRIPTION OF THE DRAWINGS

For a fuller understanding of the nature and objects of the invention, reference should be made to the following detailed description, taken in connection with the accompanying drawings, in which:

FIG. 1 shows a preferred embodiment diagram of the instrument of this disclosure.

### DESCRIPTION OF THE PREFERRED EMBODIMENT

Raman Spectroscopy is a powerful technique for the analysis of a wide range of materials and so is used in a range of applications to identify and measure samples of materials to, for example, determine if they are pure or to identify impurities within them.

However, the technique in general use requires the use of lasers for the illumination source, optics to manage the illumination and Raman signal, a spectrometer to disperse the signal into its spectral components, a detector which must cover the spectrum over which a signal must be detected and software to both operate the system and assist in interpreting the results. General purpose instruments then match the collected spectrum to those in a library to determine which substance is being analyzed. More specific instruments analyze the spectrum to determine if it is in fact a particular substance, for example a known illegal substance or a raw material for legal pharmaceuticals, or to determine if the raw material has any impurities.

However, in some applications the existence of a certain peak, or possibly peaks, in a material is enough to identify its presence or not. In such cases it is not necessary to collect the whole Raman spectrum, but simply to collect the signal from the wavenumber(s) which are unique to the substance of interest.

In such cases a vastly simplified instrument can be created using a laser still, but with much simpler optics since it is only necessary to control the illumination laser and one (or just a few) wavelength(s) of signal light, and a, or possibly a few, single point detector(s) is all that is required to collect the signal(s). It is therefore possible to create a range of instruments designed specifically to detect one substance only using this simplified optical arrangement thereby reducing the cost of the instrument dramatically.

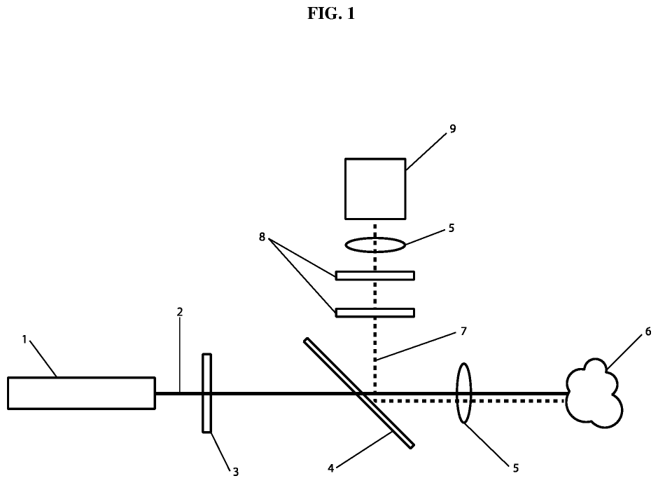

As shown in FIG. 1 a simple instrument of the preferred embodiment of this invention that can be used for the Raman analysis is disclosed. The preferred embodiment is comprised of a laser (1) emitting an illumination (2) that passes through a dichroic mirror (4); then through a lens (5); and then strikes the sample (6). An emission signal (7), created when the laser (1) illumination (2) stimulates the electrons in the sample (6) to a higher energy state and then return to a lower energy state is emitted from the sample (6); passes through the lens (5); and then back to the dichroic mirror (4); where it is reflected and then passes through one or more narrow band filters (8); through a lens (5); and on to the detector (9).

An extension of the preferred embodiment is to replace the detector (9) with an array of detectors (not shown) or use a detector array (not shown) so that a wider field of view is observed for applications such as inspection or sorting on a conveyor belt. Also, a laser clean up filter (3) can be added if the laser (1) illumination (2) is not clean enough such that the illumination (2) from the laser (1) passes through the laser clean up filter (3) before passing through the dichroic mirror (4).

Since certain changes may be made in the above-described instrument and method of using a narrow range or single wavelength Raman analyzer without departing from the scope of the invention herein involved, it is intended that all matter contained in the description thereof shall be interpreted as illustrative and not in a limiting sense.

What is claimed is:

1. A narrow range or single wavelength Raman analyzer system comprising:
a laser;
said laser emitting an illumination;
said illumination then passing through a dichroic mirror;
said illumination then passing through a first lens;
said illumination then striking a sample under test and said sample under test creating an emission signal;
said emission signal then passing back through said first lens;
said emission signal then reflecting off of said dichroic mirror;
said emission signal then passing through one or more narrow band filters; and, said emission signal passing through a second lens and onto a detector.

2. The narrow range or single wavelength Raman analyzer system of claim 1 wherein said detector is an array of detectors or a detector array.

3. The narrow range or single wavelength Raman analyzer system of claim 1 wherein if said laser is not clean enough a laser clean up filter is added such that said illumination from said laser passes through said laser clean up filter before passing through said dichroic mirror.

4. The narrow range or single wavelength Raman analyzer system of claim 2 wherein if said laser is not clean enough a laser clean up filter is added such that said illumination from said laser passes through said laser clean up filter before passing through said dichroic mirror.
